(19) United States
(12) Patent Application Publication
(10) Pub. No.: US 2007/0040705 A1
(43) Pub. Date: Feb. 22, 2007

(54) Unsafe location warning system

(75) Inventors: Satomi Yoshioka, Yokohama-city (JP); Ichiro Yoshida, Takahama-city (JP); Tsuyoshi Nakagawa, Aichi-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/498,231

(22) Filed: Aug. 3, 2006

(30) Foreign Application Priority Data
Aug. 19, 2005 (JP) 2005-238645

(51) Int. Cl. G08G 1/123

(52) U.S. Cl. 340/988

(57) ABSTRACT

A location warning system in a vehicle includes a position detector for detecting a vehicle position, a storage system for storing unsafe location information in a database, and a visual representation control means for visually representing the unsafe location information in a view of a driver of the vehicle when the vehicle is expected to pass the unsafe location. The unsafe location information defines a location of the unsafe factor as an unsafe location in association with the unsafe factor that affects a driving operation of the vehicle.

### CROSS REFERENCE TO RELATED APPLICATION

This application is based on and claims the benefit of priority of Japanese Patent Application No. 2005-238645 filed on Aug. 19, 2005, the disclosure of which is incorporated herein by reference. This application is also related to U.S. application Ser. No. 11/451337, entitled “VEHICLE DRIVE ASSIST SYSTEM,” filed on Jun. 13, 2006.

### FIELD OF THE DISCLOSURE

The present disclosure generally relates to an unsafe location warning system in a vehicle.

### BACKGROUND OF THE DISCLOSURE

Conventionally, a navigation system in a vehicle navigates a driver of the vehicle to a destination by providing a navigation route based on map data and user preference once the destination is inputted by the driver or a user. The driver, or the user, inputs his/her preference such as use of a toll road, a stop-by place setting or the like according to their convenience. Further, the navigation system may receive traffic information from an external resource for avoiding a traffic congestion expected in the navigation route.

A system disclosed in Japanese patent document JP-A-2003-123185 describes a technique that utilizes location information regarding an unsafe, risky situation or the like uploaded to a server from terminals. The location information is, for example, transferred to the vehicle for avoiding an unsafe location in the navigation route, for providing a warning prior to a passage through the unsafe location or for a like process.

However, the driver may not necessarily think of a proper response to the warning prior to the passage through the unsafe location when he/she does not understand the meaning of the warning, i.e., a specific nature of the unsafe condition. As a result, the warning may not effectively be made use of by the driver in some cases.

### SUMMARY OF THE DISCLOSURE

In view of the above-described and other problems, the present disclosure provides an unsafe location warning system that provides for a driver a factual support information of unsafe conditions when the driver travels an unsafe location by driving a vehicle.

The unsafe location warning system in a vehicle includes a position detector for detecting a vehicle position, a storage system for storing unsafe location information in a database, and a visual representation control means for visually representing the unsafe location information in a view of a driver of the vehicle when the vehicle is expected to pass through the unsafe location. The unsafe location information defines a location of an unsafe factor as the unsafe location in association with the unsafe factor itself that affects a driving operation of the vehicle. In this manner, the driver of the vehicle can expect the unsafe factor ahead of the passage through the unsafe location in a concrete manner. Therefore, the driver can easily take measures for avoiding the unsafe factor beforehand.

In another aspect of the present disclosure, the unsafe location warning system having various sensors and data storage device records the unsafe location in association with attributes of an unsafe factor/condition at the unsafe location based on a physical response of the driver, driving operation, and other information such as traffic information from an external resources or the like. The recorded unsafe location and the attributes of the unsafe condition are used later in a travel that passes through or runs close to the unsafe location for avoiding the unsafe condition.

In yet another aspect of the present disclosure, data of the unsafe location and the unsafe condition are transferred to an external storage for recording, and are distributed to other vehicles. In this manner, information of the unsafe locations are collectively stored in a database or the like for further utilization by sharing.

In still yet another aspect of the present disclosure, the driving skill of the driver is evaluated and stored as data by the warning system for variably controlling visual representation provided for the driver. In this manner, the driver of the vehicle can have a suitable feedback according to his/her driving skill level.

In still yet another aspect of the present disclosure, the driver can have the navigation route prepared in accordance with the preference in terms of avoidance of the unsafe location and the like. The navigation route may automatically be calculated to avoid the unsafe location for the improvement of safety in driving.

### BRIEF DESCRIPTION OF THE DRAWINGS

Other objects, features and advantages of the present disclosure will become more apparent from the following detailed description made with reference to the accompanying drawings, in which:

FIG. 1 shows a block diagram of a driver support system in a first embodiment of the present disclosure;

FIG. 2 shows a flowchart of a hazard map display process;

FIG. 3 shows an illustration of a roughly calculated navigation route;

FIG. 4 shows a flowchart of a hazard map generation process;

FIG. 5 shows a flowchart of a driving operation detection process in association with the process in FIG. 4;

FIG. 6 shows a flowchart of a visual representation preparation process at an unsafe point;

FIG. 7 shows a flowchart of an abnormal object extraction/categorization/positioning process in association with the process in FIG. 5;

FIGS. 8A and 8B show illustrations of visual representation of objects on a display unit; and

FIG. 9 shows a flowchart of a hazard map display process in a second embodiment of the present disclosure.

### DETAILED DESCRIPTION OF THE PREFERRED EMBODIMENTS

Embodiments of the present disclosure are described with reference to the drawings.

### First Embodiment

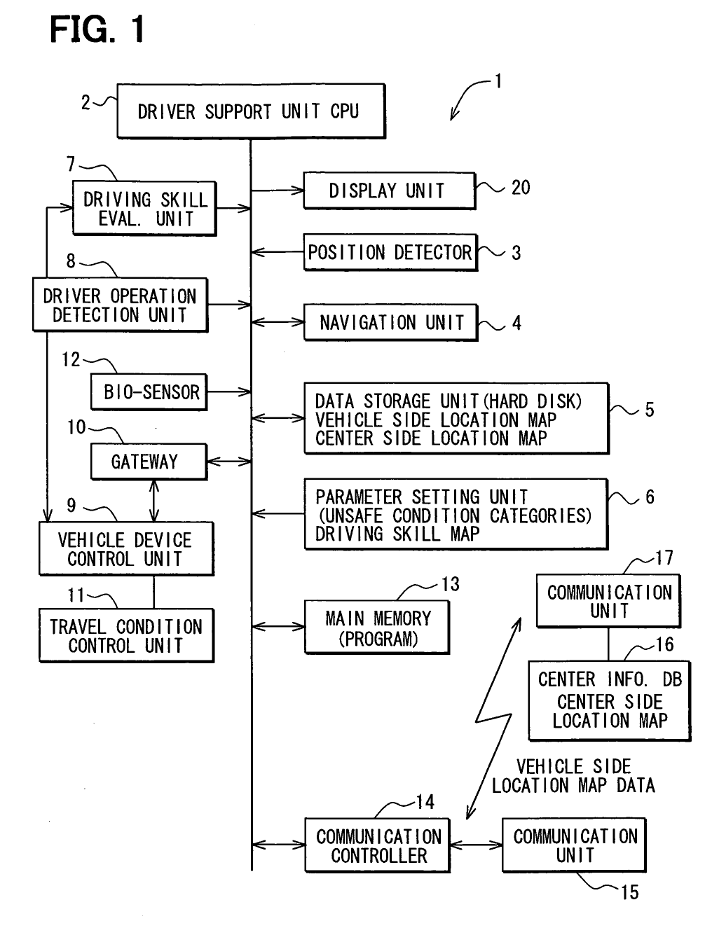

FIG. 1 shows a block diagram of a driver support system 1 in a first embodiment of the present disclosure. The driver support system 1 on a vehicle has a navigation function, and includes a driver support unit CPU 2 that controls components in the driver support system 1. The components in the driver support system 1 includes a position detector 3, a navigation unit 4, a data storage unit 5, a parameter setting unit 6, a driving still evaluation unit 7, a driver operation detection unit 8, a vehicle device control unit 9, a gateway 10, a travel condition control unit 11, a biometric sensor 12, a main memory 13, a communication controller 14, and a communication unit 15.

The position detector 3 includes a GPS (Global Positioning System) receiver, and detects/determines a vehicle position. The navigation unit 4 calculates a navigation route based on an input of a destination from a driver, and provides a calculation result, e.g., a navigation route, for the driver so as to navigate the driver toward the destination of a travel.

The data storage unit 5 is, for example, a database that utilizes a hard disk driver for storing a location map of unsafe conditions. The location map of the unsafe conditions is described later as a hazard map. The location map also stores map data for navigation route calculation. The parameter setting unit 6 is used to set parameters for unsafe condition data described later. The driving skill evaluation unit 7 evaluates a driving skill of the driver based on driver operation information regarding a steering wheel operation, an accelerator operation, a brake operation, a handbrake operation and the like detected by the driver operation detection unit 8. The driver operation detection unit 8 includes cameras or like devices for imaging a front view, a side view, and a rear view of the vehicle.

The vehicle device control unit 9 controls vehicle devices upon receiving operation information from the driver operation detection unit 8, and communicates with the driver support unit CPU 2 through the gateway 10 for a vehicle LAN or the like. The travel condition control unit 11, e.g., an ECU (an electronic control unit or the like) controls an actual travel of the vehicle according to a travel situation/condition of the vehicle.

The biometric sensors 12 are in contact with a driver's body at various positions for detecting a mental condition of the driver. For example, driver's physical responses such as a heart rate, a blood pressure, perspiration, body temperature are detected and recorded as physical response data. The biometric sensors 12 include a face camera for imaging complexion, look direction, and/or safe confirmation operation of/by the driver while the driver is operating the vehicle. The biometric sensors 12 also include a foot camera for imaging an accelerator/brake operation by the driver.

The main memory 13 stores a control program that is executed by the driver support unit CPU 2. The communication controller 14 is an interface between the driver support unit CPU 2 and the communication unit 15. Data format of the communication exchanged between the CPU 2 and the communication unit 15 is determined and converted by the communication controller 14. The communication unit 15 exchanges data with the communication unit 17 in a control center 16. In this manner, the driver support unit CPU 2 uploads and downloads location map data to and from the database in the control center 16.

The location map in the control center 16, i.e., a center side location map of the unsafe condition of the vehicle or the like, is stored in the database after sorting and categorizing the unsafe condition. That is, the location map data of each unsafe condition uploaded from an individual vehicle is categorized by, for example, a degree of danger, an unsafe object, an environmental factor and the like, and is associated with an ID number in the database. The driver of the individual vehicle can request for the location map of the unsafe condition (can send a request for a download) to the control center 16 to obtain the location map data that is suitable for a current vehicle location and the destination of the travel. The location map data to be downloaded by the driver includes location information of the unsafe condition (i.e., information on an unsafe location), a frequency of the unsafe condition, a degree of the unsafe condition level (e.g., a degree of slippery condition when a road surface is frozen or covered by a snow, or a degree of visibility when a fog is rolling), and an attribute of an unsafe condition area (an area size, a representation form (two-dimension, three-dimension) etc.).

The location map of the unsafe conditions in the individual vehicle, i.e., a vehicle side location map, stores an event of the unsafe condition as a time of the event and the vehicle location of the unsafe condition in association with an abrupt operation by the driver (an operation of a steering wheel/accelerator/brake etc.) or in association with an external event that is assumed to have caused an agitation of a driver's mental condition as well as the environmental factor (weather conditions such as a temperature, a wind speed or the like) at the time of the event of the unsafe condition after categorization by the parameter setting unit 6. The weather conditions may be acquired by using weather sensors in the vehicle or may be received from an external information resource by the communication unit 15.

The vehicle side location map may be used for recognition and evaluation of operation characteristics of the driver. For example, when the driver watches out for an oncoming traffic at a stop sign of an intersection, the number of confirmation operations for traffic clearance in right/left directions is counted and recorded in association with the number of the event of the unsafe conditions resulting from an overlook of the oncoming traffic from a left direction at the intersection as a weak point of the driver's operation characteristic. The vehicle side location map may further be used to cover up driver's weakness by providing for the driver a warning message that sounds “Watch out for the left side traffic” in a similar situation. The vehicle side location map may provide for the driver another form of warning by emphasizing a left side view of the vehicle taken by an onboard camera for imaging the surroundings of the vehicle.

The information on the unsafe location has parameters for categorizing a road condition, a weather condition and the like. That is, the information on the unsafe location is associated with an actual travel condition of the vehicle and the road/weather condition parameters. In this manner, the information on the unsafe locations in, for example, a snowy weather is extracted from the database of the center side location map and is downloaded to the vehicle when the weather information of the destination of the travel forecasts a snow.

The driver support system 1 includes a display unit 20 for projecting an image on a surface of a windshield of the vehicle, i.e., a so-called headsup display unit. The display unit 20 may be a display device that displays an image by itself.

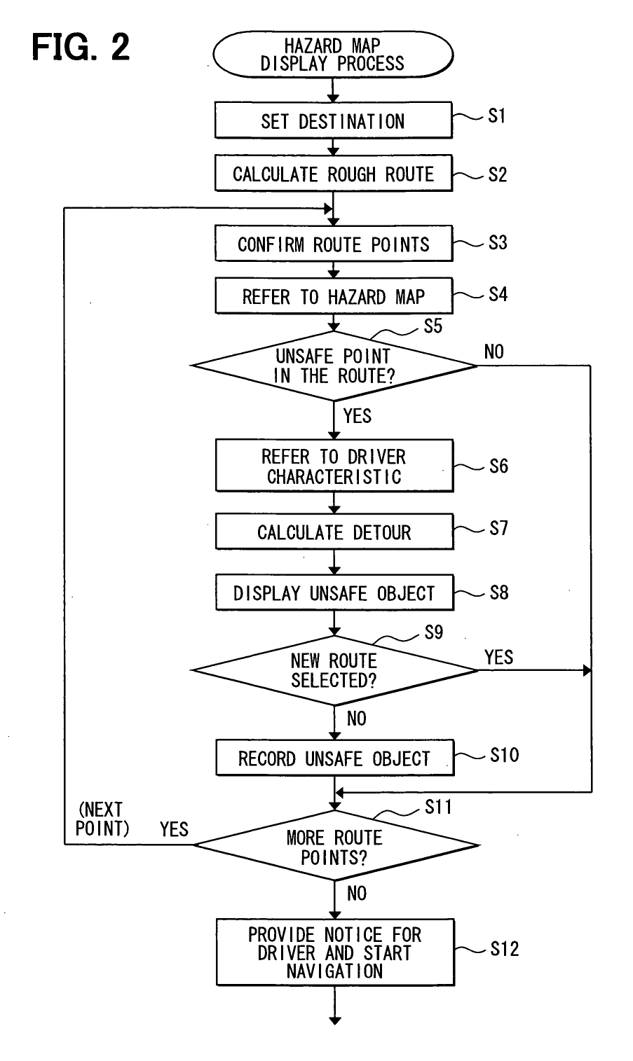

FIG. 2 shows a flowchart of a location map display process. The location map display process is executed mainly by the driver support unit CPU 2 and the navigation unit 4 for calculating a navigation route and for displaying the location map of the unsafe conditions.

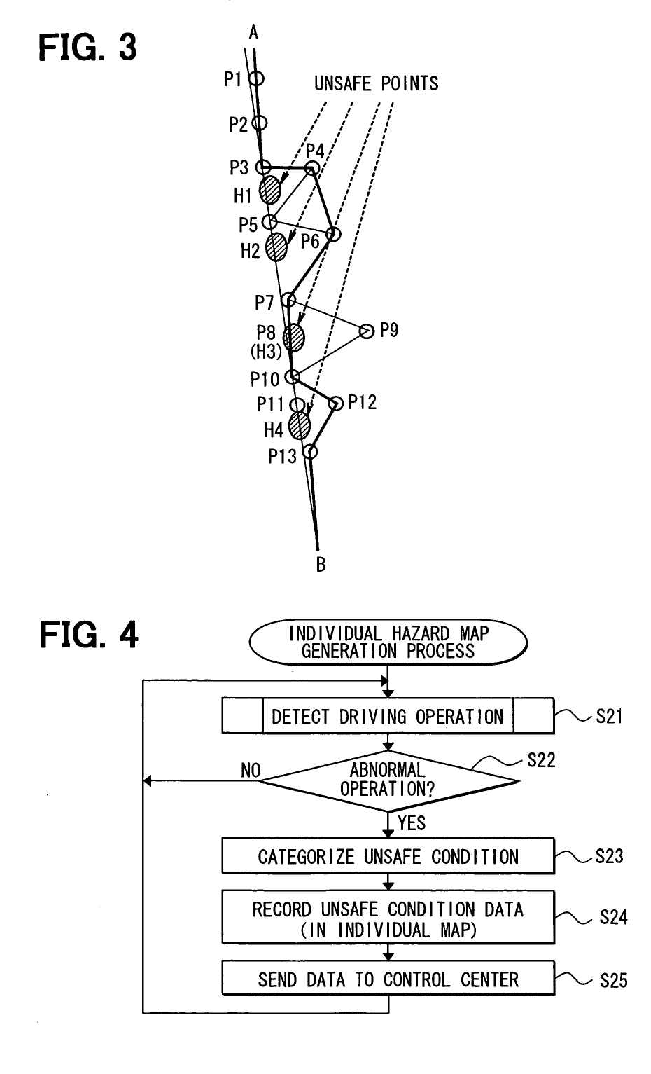

In step S1, the process determines the destination of the travel inputted by the driver. Then, in step S2, the process calculates the navigation route to the destination without considering the location map of the unsafe condition (a rough route calculation by a normal calculation process). For example, as shown in FIG. 3, a straight route between a point A and a point B is calculated as the navigation route. The location map of the unsafe condition is, in this case, the map of locations at which the driver (a current driver and/or other drivers) of the vehicle experienced an unsafe condition in the past. The unsafe condition experienced by the driver is usually reflected to a physical response of the driver such as an increased heart rate or an abrupt driving operation that is not observed in a normal driving condition. Therefore, the location map of the unsafe condition, or a hazard map, is generated as a collection of mapped points at which an abnormal physical response and/or an abnormal driving operation is observed. In the following description, the hazard map is either of a center hazard map downloaded from the control center 16, or a vehicle hazard map that is a collection of the abnormal response/operation on the individual vehicle.

In steps S3 and S4, the process refers to the hazard map in the data storage unit 5 after confirming each of route points in the navigation route by the rough route calculation is step S2.

In step S5, the process determines whether an unsafe point is found in the rough navigation route. The hazard map referred to in step S4 may be either or both of the center hazard map and the vehicle hazard map. The process proceeds to step S11 when no unsafe point is found in the route (step S5: NO). The process proceeds to step S6 when the unsafe point is found in the route (step S5: YES).

In step S6, the process refers to records of driver's operation characteristic. Then, in step S7, the process calculates a new route that bypasses the unsafe point according to the operation characteristic. The process proceeds to step S8 after calculating the new route.

In step S8, the process displays an unsafe object that caused the unsafe condition at the unsafe point as a visual representation on the display unit 20. The image of the unsafe object experienced and captured in the past by the camera may be used as the visual representation. The process proceeds to step S9 after displaying the visual representation.

In step S9, the process determines whether the driver has selected the newly calculated navigation route after confirming the unsafe object on the display unit 20. The process proceeds to step S10 when the driver desires to take the original navigation route (rough route) having the unsafe point (step S9:NO). The process proceeds to step S11 when the driver takes the new route (step S9:YES).

In step S10, the process records the unsafe object as unsafe object data in association with the unsafe point in the route. The process proceeds to step S11 after recording the data.

In step S11, the process returns to step S3 when there is a route point to be processed (step S11:YES), or the process proceeds to step S12 when there is no remaining route points to be processed (step S11:NO).

In step S12, the process displays a notice for the driver before starting the route navigation.

An update of traffic conditions may be retrieved by the communication unit 15 from the external resource. For example, a severe weather condition such as a heavy rain or the like, lane closure due to a construction work may be considered by the parameter setting unit 6 when the navigation route is calculated.

FIG. 4 shows a flowchart of a hazard map generation process.

In steps S21 and S22, the process in the CPU 2 detects the driving operation of the driver by the driver operation detection unit 8, and returns to step S21 when no abnormality is detected in the operation (step S22:NO). The process proceeds to step S23 when the abnormality is detected in the driving operation (step S22:YES).

In step S23, the process categorizes the unsafe condition by the parameter setting unit 6. The process proceeds to step S24 after categorizing the unsafe condition.

In step S24, the process records the unsafe condition data in association with the vehicle position and the time of the event of the unsafe condition in the data storage unit 5. Then, in step S25, the process sends the data of the unsafe condition to the control center 16 through the communication controller 14 and the communication unit 15.

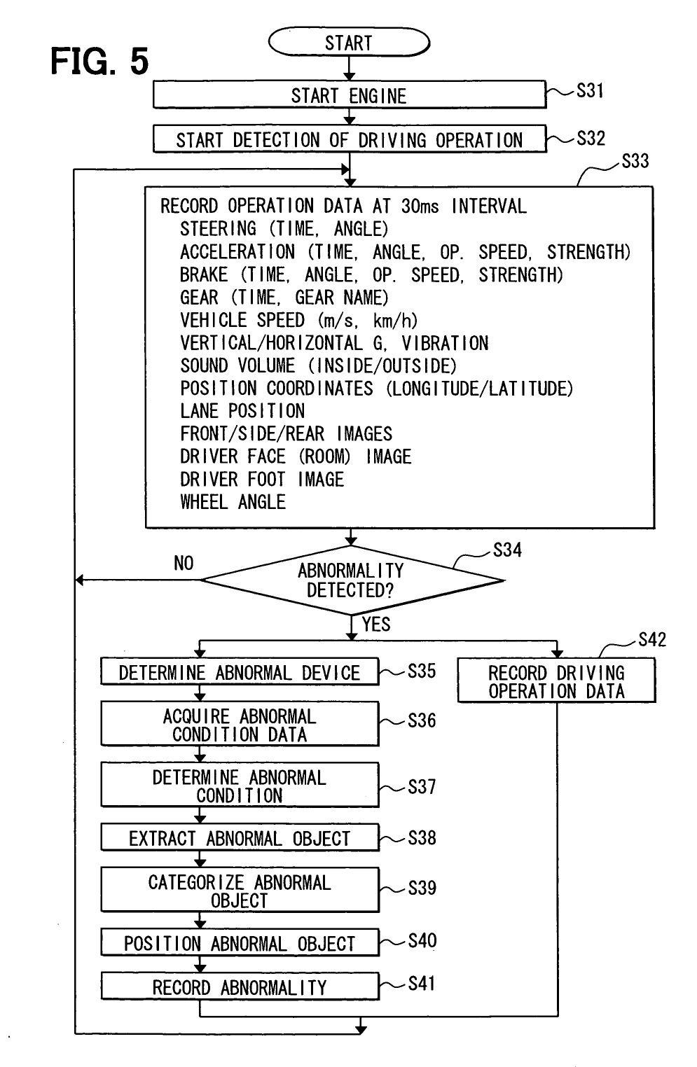

FIG. 5 shows a flowchart of details of a driving operation detection process associated to the process in step S21 in FIG. 4. The driving operation detection process runs in parallel with the process in FIG. 4, and the process in step S21 corresponds to the process in step S33 in FIG. 5.

In steps S31 and S32, the process detects the driving operation after an engine of the vehicle is started.

In step S33, the process repeats detection operation at an interval of 30 ms for detecting the driving operation. The driving operations of the following items are detected and recorded in step S33 by the driver operation detection unit 8. For example, the driving operation includes a steering operation (time, angle), an accelerator operation (time, angle, operation speed (degree/sec)), a brake operation (time, angle, operation speed (degree/sec), press strength), a gear operation (time, gear name), a vehicle speed (m/s, km/h), a vertical/horizontal acceleration value and vibration, a sound volume (inside, outside), a vehicle coordinate (longitude, latitude), a lane position, a front/side/rear image, a driver face (room) image, a driver foot image (for observation of accelerator/brake operations), a wheel angle and the like

In step S34, the process determines whether an abnormality is detected in the driving operations or in physical responses derived from the biometric sensor 12. The abnormality in the driving operation is detected and determined when the driving operation is out of an expected range of operation based on a current driving condition of the vehicle. For example, the following conditions are considered as an abnormality in terms of the driving operation.

(1) An abrupt steering operation in a straight portion or a gentle curve portion of a road;

(2) A sudden braking operation when no braking operation is required; or

(3) A steep increase/decrease of the vehicle speed.

The physical response is considered as abnormal when, for example, the heart rate or the blood pressure increases steeply. The process returns to step S33 when no abnormality is detected (step S33:NO). The process proceeds to step S35 when the abnormality is detected (step S33:YES). In this case, the process executes steps S35 to S41 and step S42 in parallel. That is, the process records the abnormality while detecting the driving operation at the interval of 30 ms.

The abnormality record process starts with the determination of the device having abnormality in step S35. Then, in step S36, abnormal condition data is acquired from the device. In step S37, the process determines the abnormal condition based on the acquired data. In this case, the abnormal condition data means the steering acceleration and the horizontal acceleration in the case (1) described above, or the vehicle speed, the brake operation speed, the acceleration, and the vibration in the case (2).

In steps S38 to S40, an abnormal object is detected/extracted, categorized and positioned. The abnormal object is a cause of the abnormality, that is, an object or an event that caused the abnormal operation of the driver. The abnormal object may be another vehicle when the abrupt steering is caused by the another vehicle darting from a side road in the case (1) described above. The abnormal object in the case (2) may be a preceding vehicle when the steep decrease of the vehicle speed is caused by a sudden stopping of the preceding vehicle. In other cases, the abnormal object may be a frozen road surface, a dropped object on a road, a pedestrian or the like. The abnormal object is extracted and categorized from the image of the surroundings of the vehicle, and position of the abnormal object is determined relative to the position of a subject vehicle. After executing above processes, the abnormal condition including the abnormal object is recorded in step S41. The process in step S23 in FIG. 4 utilizes the data recorded in step S41.

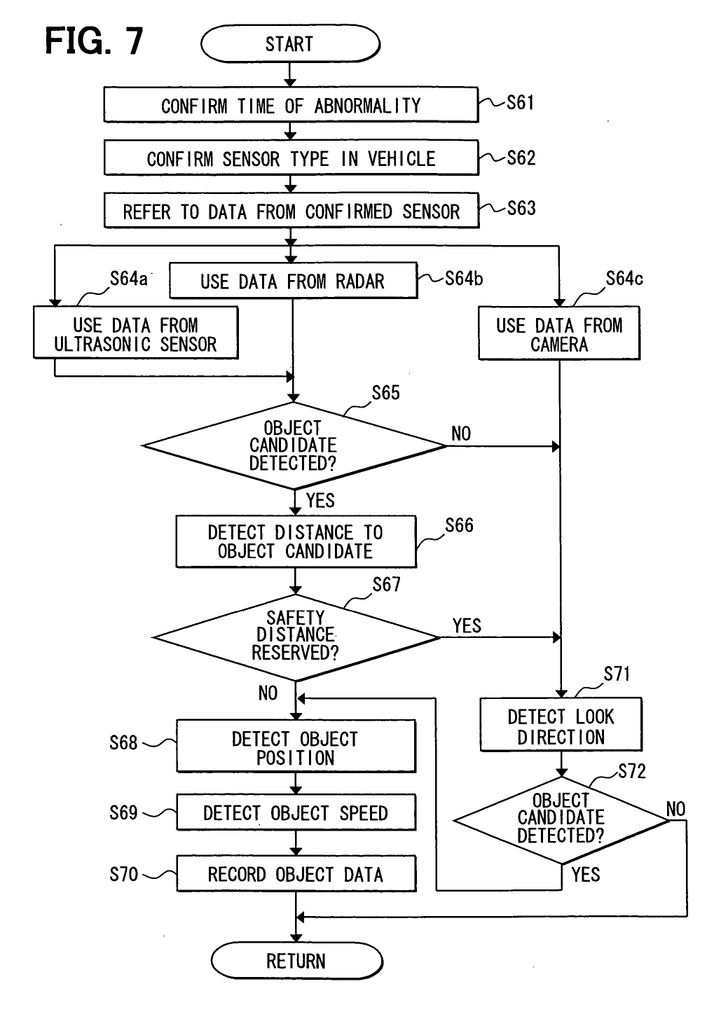

FIG. 7 shows a flowchart of details of the abnormal object extraction/categorization/positioning in steps S38 to S40 in FIG. 5.

In step S61, the process refers to and records the time of abnormality detection (YES branch) in step S34 in FIG. 5. In step S62, the process confirms what type of sensor is used in the vehicle for the abnormality detection. Then, in step S63, the process refers to the data detected and recorded by the sensor that is confirmed in step S62. In this case, the camera for watching the driver described in step S33, an ultrasonic sensor for detecting an object in the surroundings of the vehicle, a radar are used as the sensor. The data from the sensor is referred to retrospectively from the time of the event of the abnormal condition. The data from the ultrasonic sensor (step S64a) and the radar (step S64b) is used to determine whether an abnormal object candidate exists around the vehicle in step S65. When the object candidate is detected (step S65:YES), the process detects a distance to the object in step S66. In this case, the distance to the object is detected by the radar.

In step S67, the process determines whether the distance is long enough for the safety of the vehicle. When the distance is not long enough, the object is determined to be unsafe, and the position and the speed of the object is detected in steps S68 and S69. When the object is fixed on the road, the speed is determined to be zero.

In step S70, the process records the position and the speed as the object information and returns to a parent process.

The image from the camera (step S64c) is used to determine a look direction of the driver in step S71, and the look direction is examined to have the object candidate in step S72. The process in step S72 determines the look direction even after a negative determination in step S65 (i.e., no object found), because the ultrasonic sensor and the radar can detect only limited types of objects. The process proceeds to step S68 when the object candidate is detected (step S72:YES), and the process returns to the parent process when no object candidate is detected (step S72:NO).

Further, when a slippery condition due to a construction work or the like caused the unsafe condition for the driver, the operation of ABS for preventing the slip is recognized as the unsafe condition and recorded as the data in the map. The data is sent to the control center 16 in step S25 in FIG. 4, and the data stored in the control center 16 is distributed to the vehicles within the area of a predetermined range. The driver in the vehicle that received the distributed data is notified of the slippery condition by the visual representation or the voice warning when the vehicle approaches the unsafe point recorded in the data.

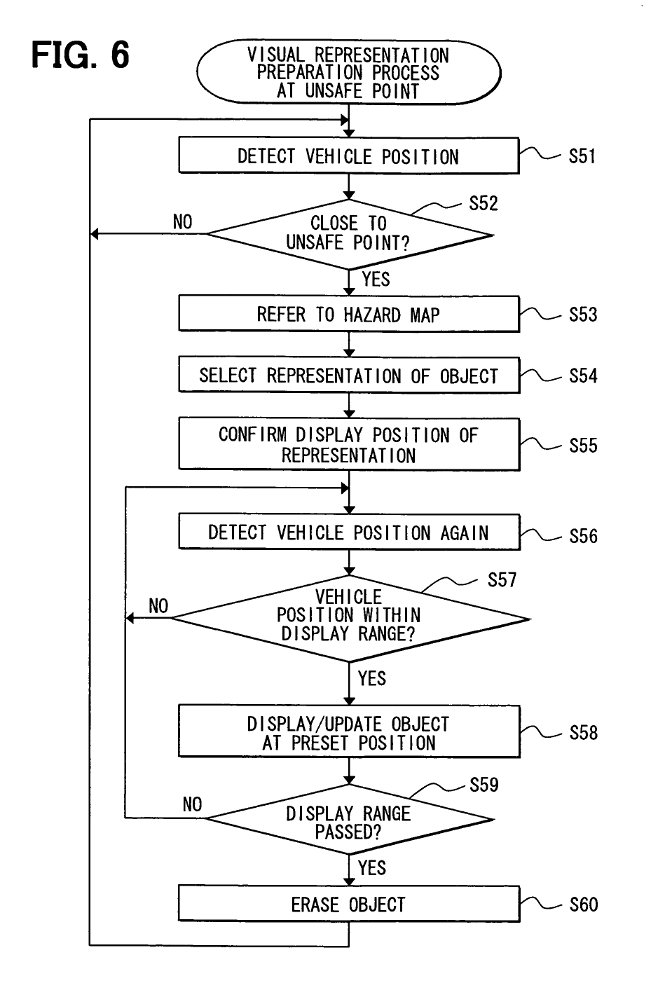

FIG. 6 shows a flowchart of a visual representation preparation process at the unsafe point. The process is controlled by the CPU 2 for displaying the visual representation on the display unit 20.

In step S51, the process detects the vehicle position, and determines whether the vehicle position is close to the unsafe point in step S52. The process proceeds to step S53 when the vehicle position is close to the unsafe point (step S52:YES). The process returns to step S51 when the vehicle position is not close to the unsafe point (step S52:NO).

In step S53, the process refers to the hazard map in the data storage unit 5.

In step S54, the process selects an object to be represented when the vehicle approaches the unsafe point.

In step S55, the process confirms a display position of the selected object.

In step S56, the process detects the vehicle position again.

In step S57, the process determines whether the vehicle position is within a predetermined range for displaying the selected object. The process proceeds to step S58 when the vehicle position is within-the object display range (step S57:YES). The process returns to step S56 when the vehicle position is not within the object display range.

In step S58, the process displays the representation of the selected object at a preset position.

In step S59, the process determines whether the vehicle position is within the display range. The process returns to step S56 when the vehicle is within the object display range (step S59:NO). That is, the representation of the object is kept updated in step S58 while the vehicle position is within the object display range. The process proceeds to step S60 when the vehicle position passes the object display range (step S59:YES).

In step S60, the process erases the visual representation of the object, and then returns to step S51.

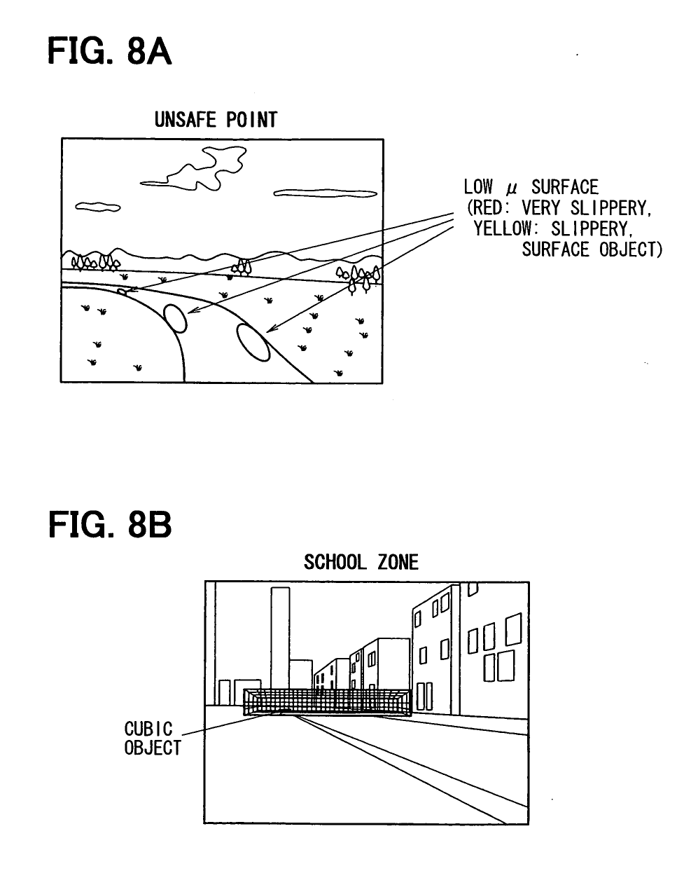

FIGS. 8A and 8B show illustrations of the visual representation of the objects on the display unit 20. FIG. 8A shows a representation of a road surface object projected on a window to be overlaid on a real sight outside of the vehicle based on position data of the hazard map of slippery road surfaces (Low μ points) within thirty minutes downloaded from the control center 16. The low μ points of the road surface ahead of the vehicle is displayed as surface objects by using colors such as a red surface of relatively low μ point (a very slippery surface), a yellow surface of relatively high μ point (a little slippery surface ) and the like.

FIG. 8B shows a representation of a school zone that is defined as a safety zone in a proximity of a school for children. The illustration shows that cubic objects is highlighted at a crossing close to a school when the vehicle approaches the crossing at the time when, for example, the children are expected to pass the crossing for going home/school. In this manner, the driver of the vehicle is warned that he/she should pay attention to the children around the crossing. The actual image of the children around the crossing may be distributed to the vehicle for further improving a degree of the warning when image data is available.

The evaluation of the driver's skill may be utilized in the following manner for the visual representation at the unsafe point and for the vehicle control. That is:

(a) The system provides for the driver who always stops at the stop sign (stop rate 95% or higher) a warning instruction for only right/left clearance at the unsafe point having the stop sign;

(b) The system provides for the drive who does not always stop at the stop sign (stop rate 80 to 95%) a warning instruction for stopping in addition to the instruction for right/left clearance at the unsafe point having the stop sign;

(c) The system provides for the driver who does not at all stop at the stop sign (stop rate less than 50%) a warning instruction for stopping accompanied by an automatic braking when the vehicle passes a braking point for the stop sign without braking operation.

(d) The system provides for the driver who tends to have a late braking timing (a braking timing being too late for stopping at the stop sign or relative to a driving speed) an advanced braking instruction.

Further, the vehicle may upload an emergency unsafe information to the control center 16. For example, conditions such as the submergence of the vehicle into a water or the falling in a ditch/gutter may be uploaded to the control center 16. In this case, the system in the vehicle becomes inoperable when the vehicle is completely submerged in the water. Therefore, in this case, the emergency unsafe information is sent to the control center 16 just before the system halt.

The control center 16 distributes the emergency unsafe information to the vehicles around the vehicle that originally reported the submergence. The information of the submergence may be distributed as an forced distribution. The information may include an image of the submerging vehicle for a representation on the display unit 20 of the vehicle. The driver in the vehicle that received the emergency unsafe information can determine a condition of emergency and/or safety based on the vehicle position at the time of reception relative to the distribution of the source of the emergency unsafe information, the area of the unsafe condition, and area change (increase/decrease) of the unsafe condition.

The disclosure of an unsafe location warning system in the present embodiment is summarized as follows. That is, the unsafe location warning system as a part of the driving support system 1 is controlled by the CPU 2, and displays on the display unit 20 information of the unsafe point in the hazard map stored in the data storage unit 5 when the vehicle approaches the unsafe point based on the detected vehicle position. The information of the unsafe point includes an unsafe condition caused by an object/event at the unsafe point. The information is visually represented and projected on a windshield as an overlaid image on an actual sight from the vehicle. In this manner, the driver of the vehicle can have a concrete idea what kind of unsafe condition is expected at the unsafe point. Therefore, the driver can take precautionary measures against the unsafe condition for the ease of driving.

The CPU 2 records the unsafe point based on at least one of the data and information derived from the driver operation detection unit 8, the biometric sensors 12, and the communication unit 15 when the object that may affect the vehicle operation is detected during the travel of the vehicle. The unsafe point is stored as data in the data storage unit 5. In this manner, data of the unsafe points are utilized for avoiding the unsafe condition at the unsafe point when the vehicle travels close to or passes through the unsafe point in the future.

The CPU 2 sends the unsafe point information to the external device, and received it from the external device for storage in the data storage unit 5 through the communication unit 15. In this manner, the unsafe point information collected from the individual vehicles is used to form a database of the unsafe point information in a separate location. Further, the information of the unsafe point increases as the vehicle travels various roads and areas.

The driving skill evaluation unit 7 is used to determine the level of the driving skill based on the vehicle operation data recorded by the driver operation detection unit 8. Then, the CPU 2 controls the representation of the object displayed on the display unit 20 according to the evaluation of the driving skill. In this manner, the object causing the unsafe condition is suitably presented for each driver.

The navigation unit 4 refers to the unsafe point information in the data storage unit 5 for avoiding the unsafe point that may otherwise be included in the navigation route to the destination. In this manner, a safer navigation route is calculated and proposed by the navigation unit 4. In addition, the navigation unit 4 takes driver's preference into account based on a setting, thereby allowing the driver to choose trade-offs between a safer but longer route and a less safer but shorter route to the destination.

### Second Embodiment

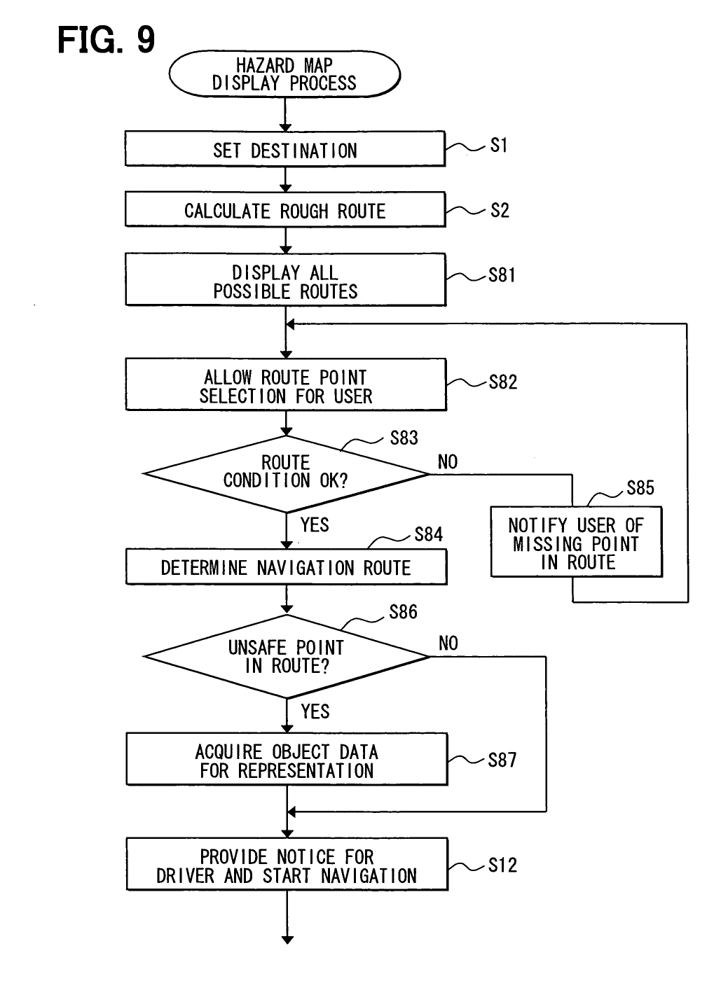

FIG. 9 shows a flowchart of the hazard map display process in a second embodiment of the present disclosure. Like parts have like number as designated in the first embodiment. Description of the second embodiment is focused to a part that is different from the first embodiment. FIG. 9 shows a flowchart that corresponds to the one in FIG. 2 in the first embodiment.

In step S2, the process calculates the rough route to the destination set in step S1, and then displays all available routes in step S81.

In step S82, the process allows the driver to select route points in respective routes for defining the route according to the preference. In this case, the unsafe points in the route are displayed for reference.

In step S83, the process determines whether a route condition is OK, that is, the route is defined according to the driver's preference. The process proceeds to step S84 when the route is defined (step S83:YES). The process proceeds to step S85 when the route is not defined (step S84:NO).

In step S84, the process determines the navigation route, and proceeds to step S86.

In step S85, the process notifies the driver that more route point is required for the route definition. The process returns to step S82 after the notification of missing point in the navigation route.

In step S86, the process determines whether the unsafe point exists in the navigation route. The process proceeds to step S87 for displaying the unsafe (abnormal) object at the unsafe point in the navigation route when the unsafe points exist in the navigation route (step S86:YES), or the process skips step S87 when there is no unsafe point in the navigation route (step S86:NO). That is, the process acquires object data in step S87 for the visual representation. The process proceeds to step S12 described in the first embodiment after either of step S86 or S87.

The situation of the process in FIG. 9 is illustrated in FIG. 3 by a thick solid line. That is, the driver selected point P1, P2, P3, P4, P6, P7, P8, P10, P12, and P13. In this case, the unsafe points exist between P3 and P5 (H1), P5 and P7 (H2), and P11 and P13 (H4). The unsafe point H3 coexists with the point P8. Therefore, the driver's selection indicates that the unsafe points H1, H2, H4 are avoided while the unsafe point H3 is accepted.

In the second embodiment of the present disclosure, the unsafe location warning system displays all possible routes to the destination based on the rough calculation by the navigation unit 4, and displays all the route points and the unsafe points for allowing the driver to choose from them. In this manner, the driver can define the navigation route that has the selected route points based on the consideration of the balance between the safety of the route, the travel time and other factors.

Although the present disclosure has been fully described in connection with the preferred embodiments thereof with reference to the accompanying drawings, it is to be noted that various changes and modifications will become apparent to those skilled in the art.

For example, the hazard map may be used for evaluation of the driver's skill in the following manner. That is, the unsafe condition in an actual travel of the vehicle is detected and recorded for comparison with records in the hazard map. Then, the driver may reflect on his/her own driving operation for improvement based on the comparison between the records and unsafe condition in the actual travel such as the steering wheel operation in reverse travel, side spacing with another vehicle, an inner wheel path difference in turning or the like.

Further, the lane width in the navigation route may be considered in a preferable navigation route calculation with additional information on the number of parked cars on the roadside in a specific time slot.

The hazard map may be stored only in the vehicle instead of sending data to the control center 16 (i.e., data upload). The hazard map may only be distributed by using a storage medium such as a CD-ROM, DVD-ROM or the like. The hazard map may only be downloaded from the control center 16 by the communication unit 15.

The navigation function and the unsafe point presentation function may be combined for calculating the unsafe point free navigation route, or may be separately used for simply providing an unsafe point warning.

Utilization of the driving skill evaluation function for changing the form of the visual representation according to the driving skill level may be optional.

The unsafe location information in the hazard map may be projected on the windshield, or may be represented on a map for displaying detailed road information of the navigation route.

The unsafe location information may be provided by adding text message in the visual representation.

The vehicle position may be determined based on information received from an infrastructure of positional information such as Vehicle Information and Communication System developed in Japan.

Such changes and modifications are to be understood as being within the scope of the present disclosure as defined by the appended claims.

What is claimed is:

1. A location warning system in a vehicle comprising:
a position detector for detecting a vehicle position;
a storage system for storing unsafe location information in a database, wherein the unsafe location information that defines a location of an unsafe factor as an unsafe location in association with the unsafe factor that affects a driving of the vehicle; and
a visual representation control means for visually representing the unsafe location information in a view of a driver of the vehicle when the vehicle is expected to pass the unsafe location.

2. The location warning system as in claim 1 further comprising:
a physical response data recording means for detecting and recording a physical response data of the driver as a reflection of a mental condition of the driver;
a vehicle operation data recording means for detecting and recording vehicle operation by the driver as vehicle operation data;
a traffic information acquisition means for acquiring traffic information from an external resource; and
an unsafe location recording means for recording the unsafe location information in the database, wherein the unsafe location in the unsafe location information is determined to have the unsafe factor for the driving of the vehicle based on at least one of the physical response data, the vehicle operation data and the traffic information.

3. The location warning system as in claim 2 further comprising:
a communication unit for communicating with an external resource,
wherein the communication unit sends the unsafe location information recorded by the unsafe location recording means to the external resource, and
the unsafe location recording means records the unsafe location information received from the external resource by the communication unit.

4. The location warning system as in claim 2 further comprising:
a driving skill evaluation means for evaluating driving skill of the driver based on the vehicle operation data recorded by the vehicle operation data recording means,
wherein the visual representation control means controls visual representation of the unsafe location information in terms of representation of the unsafe factor of the unsafe location according to an evaluation level of the driving skill of the driver evaluated by the driving skill evaluation means.

5. The location warning system as in claim 4,
wherein the evaluation level of the driving skill of the driver is variably associated with formation of notification provided for the driver.

6. The location warning system as in claim 1 further comprising:
a route navigation means for calculating and providing a route navigation to a preset destination based on a map data,
wherein the route navigation means refers to the unsafe location information in the database to exclude the unsafe location from the navigation route to the preset destination.

7. The location warning system as in claim 6,
wherein the route navigation means excludes the unsafe location from the navigation route based on an input from a user.

8. The location warning system as in claim 6,
wherein the unsafe location information is provided for the driver in combination with the route navigation.

9. The location warning system as in claim 6,
wherein the unsafe location information is visually represented on a map in combination with the navigation route based on the map data.

10. The location warning system as in claim 1,
wherein the unsafe location information in the view of the driver is overlaid on a sight of the driver.

11. The location warning system as in claim 1,
wherein the unsafe location information is visually represented by using a difference of hue.

12. The location warning system as in claim 1,
wherein the unsafe location information is visually represented by using a difference of shading.

13. The location warning system as in claim 1,
wherein the unsafe location information is visually represented by using a geometrical shape.

14. The location warning system as in claim 1,
wherein the unsafe location information is visually represented by using an image.

15. The location warning system as in claim 1,
wherein the unsafe location information is graphically represented by using a moving picture.

16. The location warning system as in claim 1,
wherein the unsafe location information is visually represented by using a graphic icon.

17. The location warning system as in claim 1,
wherein the unsafe location information is visually represented by using a text.
